(19) United States
(12) Patent Application Publication
(10) Pub. No.: US 2009/0083278 A1
(43) Pub. Date: Mar. 26, 2009

(54) SYSTEM AND METHOD FOR DISCOVERING AND PRESENTING SOCIAL RELATIONSHIPS BETWEEN INTERNET USERS AND CONTENT

(76) Inventors: Yihong Zhao, San Jose, CA (US); Xin Li, Santa Clara, CA (US)

Correspondence Address: YAHOO! INC.;C/O Ostrow, Kaufman & Frankl LLP, 136 E. 57th Street, 12th Floor, NEW YORK, NY, 10022, US

(21) Appl. No.: 11/861,962

(22) Filed: Sep. 26, 2007

(51) Int. Cl. G06F 17/30

(52) U.S. Cl. 707/10; 707/E17.005

(57) ABSTRACT

Systems, methods, and computer readable media are disclosed for discovering relationships between one or more content items and one or more users. The method of the present invention comprises retrieving one or more bookmarks and one or more tags associated with one or URLs generated by one or more users. One or more sets of related tags are generated according to a frequency with which the one or more retrieved tags co-occur within a given corpus of content items. The one or more URLs associated with the one or more identified sets of related tags are identified. The one or more users that generated bookmarks for the one or more sets of related URLs are identified. A recommendation is generated for one or more tags, URLs, and users in response to receiving a bookmark for a given URL through use of the related tags, URLs, and users.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to the discovery and presentation of relationships between users and content. More specifically, the present invention relates to the discovery of relationships between users and content through the use of tag data, and the subsequent presentation of such relationships to one or more Internet users.

### BACKGROUND OF THE INVENTION

The Internet provides access to an ever increasing quantity of web sites, which may contain a wide variety of content items. Client devices, communicatively coupled to the Internet, are able to access various websites which may contain images, video, audio clips, documents, etc. Access to websites is typically made available through use of a browser installed on a client device of a given user. A given user of a client device may specify a uniform resource locator (“URL”) of a content item, e.g., a website or webpage, which the given user wishes to access.

Many users of client devices who access the Internet often view hundreds or thousands of web sites or web pages during a given time period, such as a single month. Often, users may wish to revisit a given website or webpage that contains content the user wishes to view, listen to, etc., at a later date. For example, a user may perform research on a given topic and identify a website or a webpage that contains information that the user wishes to further review. Through use of bookmark, the user may store a pointer or link to the website or webpage, allowing the user to directly access the website or webpage at a later date without having to search or spend time locating the URL associated with the website or webpage. A bookmark to a website or webpage may be stored by the Internet browser with which the bookmark was generated. Thereafter, a user of a client device may review the bookmarks stored by a given Internet browser and select a given bookmark, causing the browser to directly access the website or webpage associated with the selected bookmark.

Similarly, bookmarks for a given user to one or more content items may be stored by a bookmark storage provider, such as Yahoo!. For example, the Yahoo! MyWeb® service allows users to store bookmarks to content items in a central network accessible location, allowing users to access the bookmarks from any client device coupled to the Internet. Services, such as Yahoo! MyWeb®, may also permit users to access various bookmarks generated and stored by their friends, family members, buddies, or other members of one or more social networks to which a given user belongs.

The bookmarks generated by a given user are often associated with a wide variety of content items. For example, a given user of a client device may access a news webpage containing an article of interest to the user. Similarly, the user may access a webpage containing a video clip of a movie the user wishes to view. Additionally, the user may access a webpage containing an image file or an audio file of particular song. The user may generate a bookmark for a given one of the content items in order to gain direct access to the content items at a late date.

A user may wish to provide a categorization or label to the variety of bookmarks for various content items generated by the user. Accordingly, the bookmarks that a given user generates may be associated with one or more keywords describing given bookmarked content items, which are referred to as tags. For example, a bookmark generated for a news article associated with computers may be stored with the tags “computer,” “technology,” “news,” “article.” Similarly, a bookmark generated for a movie video clip may be stored in conjunction with the tags “video,” “funny,” “favorite clips,” whereas a bookmark generated for an audio clip may be stored with the tags “rock” “music,” “Phish,” “awesome.”

The plurality of bookmarks generated by users of client devices are typically stored in a simple structure, such as a flat file or folder on a storage device, and presented to a user of a client device in a list format with the description or tag that corresponds to a given bookmark. Though current techniques allow a given user of a client device to view bookmarks and associated tags generated by other users of client devices, current techniques for presenting books to a user of a client device fail to provide a user with information regarding relationships between the user and one or more other users that have generated bookmarks to various content items.

For example, current techniques provide a user of a client device with the ability to view the user's bookmarks and associated tags, as well as the bookmarks and associated tags of a plurality of additional users of client devices. However, current techniques fail to provide the user with an indication of relationships between tags and content items (e.g., URLs) associated with other users of client devices. In order to overcome shortcomings associated with existing techniques, embodiments of the present invention provide systems and methods for utilizing tag data associated with addresses (e.g., URLs) corresponding to bookmarks generated by one or more users of client devices to identify and present relationships between tags, content items, and users of client devices.

### SUMMARY OF THE INVENTION

The present invention is directed towards systems, methods, and computer readable media comprising program code for discovering relationships between one or more content items and one or more users. The method of the present invention comprises retrieving one or more bookmarks and one or more tags associated with one or more URLs generated by one or more users. One or more sets of related tags are generated according to a frequency with which the one or more retrieved tags co-occur within a given corpus of content items. According to one embodiment of the present invention, generating one or more sets of related tags comprises identifying a frequency with which the one or more retrieved tags co-occur within a given corpus of content items, identifying the one or more retrieved tags that co-occur above a given threshold, and generating one or more sets of related tags based upon the one or more retrieved tags that co-occur above the threshold.

Although embodiments of the invention presented herein are described in conjunction with bookmarks, tags and URLs, those of skill in the art recognize that in addition to a URL, the systems and methods of the present invention are applicable to any type of user generated content, such as a question or a blog posting, and may comprise any type of data including, but not limited to, text, images, video, etc. Similarly, in addition to utilizing tags, embodiments of the present invention may utilize one or more keywords extracted from a item of user generated content.

The method of the present invention further comprises identifying the one or more URLs associated with the one or more identified sets of related tags, wherein the one or more URLs associated with a given set of related tags comprises a set of related URLs. The one or more users that generated bookmarks for the one or more sets of related URLs associated with the one or more identifies sets of related tags are identified, wherein the one or more users associated with a given set of URLs comprises a set of related users. A recommendation is generated for one or more tags, one or more URLs, and one or more users in response to receiving an indication of a user generating a bookmark for a given uniform resource locator through use of the one or more sets of related tags, related URLs, and related users. According to various embodiments of the present invention, related tags may be used to identify topics of interest for a given user and the frequency of topics for a given user may identify a level of expertise of a given user for a given topic.

According to one embodiment of the present invention, generating a recommendation comprises receiving an indication of a user generating a bookmark for a given URL, the bookmark associated with one or more user specified tags and retrieving the one or more sets of related tags associated with the one or more user specified tags. Retrieving the one or more sets of related tags associated with the one or more user specified tags may comprise retrieving the one or more sets of related tags in which the user specified tags appear. The one or more sets of related URLs associated with the one or more sets of related tags are retrieved. Further, the one or more sets of related users associated with the one or more identified sets of related URLs are retrieved. The one or more retrieved sets of retrieved related tags, related URLs, and related users are thereafter displayed.

The one or more identified sets of related tags, related URLs, and related users may be ranked and thereafter displayed according to the ranking. According to one embodiment of the present invention, only the one or more identified sets of related tags, related URLs, and related users above a given ranking threshold are displayed.

The system of the present invention comprises a relationship component operative to retrieve one or more bookmarks and one or more tags associated with one or more URLs generated by one or more users. The relationship component generates one or more sets of related tags according to a frequency with which the one or more retrieved tags co-occur within a given corpus of content items. The relationship component is further operative to identify the one or more URLs associated with one or more identified sets of related tags, wherein the one or more URLs associated with a given set of related tags comprises a set of related URLs. Further, the relationship component is operative to identify the one or more users that generated bookmarks for the one or more sets of URLs associated with the one or more identified sets of related tags, wherein the one or more users associated with a given set of URLs comprises a set of related users.

According to one embodiment of the present invention, the relationship component is operative to identify a frequency with which the one or more retrieved tags co-occur within a given corpus of content items. The relationship component is operative to thereafter identify the one or more retrieved tags that co-occur above a given threshold, and generate one or more sets of related tags based upon the one or more retrieved tags that co-occur above the threshold.

The system of the present invention further comprises a recommendation component operative to receive an indication of a user generating a bookmark for a given URL, the bookmark associated with one or more user specified tags. The recommendation component is operative to generate a recommendation for one or more tags, one or more URLs, and one or more users associated with the one or more user specified tags through use of the one or more related tags, related URLs, and related users.

According to one embodiment of the present invention, the recommendation component is operative to receive an indication of a user generating a bookmark for a given URL, the bookmark associated with one or more user specified tags, and retrieve the one or more sets of related tags associated with the one or more user specified tags, which may comprise retrieving the one or more sets of related tags in which the user specified tags appear. The recommendation component is further operative to retrieve the one or more sets of related URLs associated with the one or more identified sets of related tags and retrieve the one or more sets of related users associated with the one or more identified sets of related URLs. The recommendation component is operative to thereafter generate a ranking of the one or more retrieved sets of related tags, related URLs, and related users. The recommendation component may be further operative to select the one or more retrieved sets of related tags, related URLs, and related users above a given threshold.

According to one embodiment of the present invention, the system of the present invention further comprises a tagging interface. The tagging interface is operative to display the one or more identified sets of related tags, related URLs, and related users selected by the recommendation component.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for discovering and presenting relationships between users and content items on the basis of tag data, according to one embodiment of the present invention;

FIG. 2 is a flow diagram presenting a method for discovering and displaying relationships between users and content items and generating a recommendation for a given user, according to one embodiment of the present invention;

FIG. 3 is a flow diagram presenting a method for discovering relationships between users and content items on the basis of tag data, according to one embodiment of the present invention; and

FIG. 4 is a flow diagram presenting a method for generating a recommendation for one or more related content items or one or more related users, according to one embodiment of the present invention.

### DETAILED DESCRIPTION OF THE EMBODIMENTS

In the following description of the embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

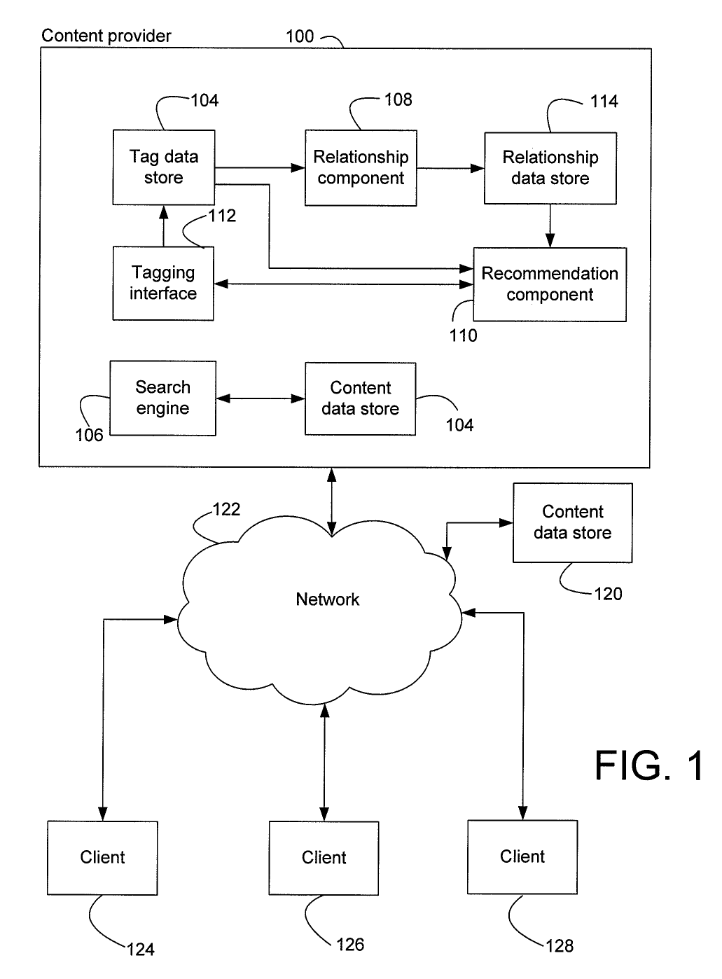

FIG. 1 presents a block diagram depicting one embodiment of a system for discovering and presenting relationships between users and content items on the basis of tag data associated with bookmarks. According to the embodiment illustrated in FIG. 1, client devices 124, 126, and 128 are communicatively coupled to a network 122, which may include a connection to one or more local and wide area networks, such as the Internet. According to one embodiment of the invention, a client device 124, 126 and 128 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A user of a client device 124, 126, and 128 communicatively coupled to the network 122 may search for content items available at one or more Uniform Resource Locators (“URL”), including but not limited to, web pages, documents, audio content, and video content through use of a search engine 106 at a content provider 100. According to the embodiment illustrated in FIG. 1, a user of a client device may deliver a request for one or more content items to the content provider 100. A search engine 106 at the content provider 100 may perform a search of one or more remote 120 or local 104 content data stores to identify one or more URLs at which content items responsive to a given request from a user of the client device 124, 126, and 128 are available.

According to another embodiment of the present invention, a user of a client device 124, 126, and 128 may direct a browser installed upon the client device 124, 126, and 128 of the user to a particular uniform resource locator (“URL”) that identifies a location of a given content item. The content item at the URL accessed via the browser accesses may comprise content items including, but not limited to, a website, an audio file, a video file, an image, a web page, document, etc.

The URL at which a given content item is available may be bookmarked by the user of a client device 124, 126, and 128. A bookmark comprises a reference to a given URL that is saved in response to a user request to generate the bookmark. According to one embodiment of the present invention, a request by a user of a client device 124, 126, and 128 to generate a bookmark for a given URL may be performed through the use of a tagging interface 112 at the content provider 100. The tagging interface 112 may comprise an interface, such as a toolbar, that is displayed upon the client device 124, 126, and 128 of a given user and with which a request to generate a bookmark may be generated.

Upon receipt of a user request to generate a bookmark, the tagging interface 112 at the content provider prompts the user of the client device 124, 126, and 128 with which the request to generate the bookmark originated to provide one or more tags for the bookmark. According to one embodiment of the present invention, a tag comprises one or more terms or phrases that a given user associates with or uses to describe a given URL. For example, the content available at a given URL may comprise a video clip describing how to setup a wireless network. A user of a client device 124, 126, and 128 may bookmark the URL at which the video clip is available. Further, the user may indicate that URL is associated with the tags “wireless,” “network” and “computer.”

The one or more tags specified by a given user of a client device 124, 126, and 128 for a given bookmarked URL are indexed by the tagging interface 112 in a tag data store 104. According to one embodiment of the present invention, the tag data store 104 maintains one or more indices of users, tags, and associated URLs. For example, a given user of a client device 124, 126, and 128 may bookmark a given URL and indicate that the tags “vacation” and “Caribbean” are associated with the bookmarked URL. The tagging interface 112 may index the bookmarked URL and the tags identified by the user as associated with the bookmarked URL, as well as information identifying the user of the client device 124, 126, and 128, such as a username, IP address, user profile, etc., in the tag data store.

The one or more URLs and associated tags generated by users of client devices 124, 126, and 128 that are maintained in the tag data store 104 may be used by a relationship component 108 to identify one or more relationships between tags, users and URLs. According to one embodiment of the present invention, the relationship component 108 is operative to periodically retrieve the one or more URLs, tags, and associated user information maintained in the tag data store 104. The relationship component 108 may initially utilize an association rule algorithm to identify one or more sets of related tags. Various association rule algorithms are known to those of skill in the art.

According to one embodiment of the present invention, a given set of related tags comprises two or more tags that frequently co-occur within the one or more tags retrieved from the tag data store 104. For example, the one or more URLs, tags, and associated user information retrieved by the relationship component 108 from the tag data store 104 may indicate that one hundred (“100”) users of client devices 124, 126, and 128 generated tags in which the terms “computer” and “laptop” co-occur. Similarly, the one or more URLs, tags, and associated user information retrieved by the relationship component 108 from the tag data store may indicate that five hundred (“500”) users of client devices 124, 126, and 128 generated tags in which the terms “vacation” and “beach” co-occur. Accordingly, the relationship component 108, through use of an association rule algorithm, may identify “computer” and “laptop” as a given set of related tags, and may similarly identify “vacation” and “beach” as a set of related tags.

According to another embodiment of the present invention, a given set of related tags comprises two or more tags that frequently co-occur within one or more blogs. For example, as previously described, a given tag associated with a bookmark comprises one or more terms. The relationship component 108 may perform a search of one or more blogs to identify one or more frequently co-occurring terms that match or are similar to the one or more tags retrieved from the tag data store 104. The terms that frequently co-occur within one or more blogs may be used to identify a given set of related tags.

According to another embodiment of the present invention, a given set of related tags comprises two or more tags that frequently co-occur within one or more questions generated by users of client devices 124, 126, and 128. For example, a question/answer service, such as Yahoo! Answers, allows users of client devices 124, 126, and 128 to post questions, comprising one or more terms, in response to which users of client devices 124, 126, and 128 may post one or more answers. According to one embodiment of the present invention, the relationship component 108 may perform a search of the one or more questions generated by users of client devices 124, 126, and 128 to find one or more frequently co-occurring terms with which related tags corresponding to the frequently co-occurring terms may be identified. Those of skill in the art recognize the plurality of content with which frequently co-occurring tags may be identified through use of an association rule algorithm.

The relationship component 108 thereafter identifies the one or more URLs retrieved from the tag data store 104 that are tagged by the one or more sets of related tags. According to one embodiment of the present invention, the one or more URLs identified by the relationship component 108 that are tagged by a given set of related tags comprise a set of related URLs. For example, a given set of related tags may comprise the tags “laptop” and “computer.” The relationship component 108 may identify one or more URLs retrieved from the tag data store 104 that are tagged with the related tags “laptop” and “computer.” The one or more URLs retrieved from the tag data store 104 that are tagged with the related tags “laptop” and “computer” comprise a set of related URLs.

According to one embodiment of the present invention, the relationship component 108 is further operative to identify the one or more users that have generated bookmarks for the one or more URLs comprising a set of related URLs associated with a given set of related tags. As previously described, the tag data store 104 maintains URLs bookmarked by users of client devices 124, 126, and 128, tags associated with URLs, and information identifying a user of a client device 124, 126, and 128 that generated the one or more tags for a given bookmarked URL. Accordingly, the relationship component 108 may utilize the information retrieved from the tag data store 104 to identify the one or more users of client devices 124, 126, and 128 that bookmarked a given URL within a given set of related URLs.

For example, a given set of related tags, as identified by the relationship component through use of an association rule algorithm, may comprise the tags “vacation” and “Caribbean.” The relationship component 108 may further identify that the URLs “www.vacation.com,” “www.caribbean.com,” “www.cruises.com,” and “www.caribbeanvacations.com” are tagged by the set of related tags “vacation” and “Caribbean,” and accordingly, comprise a set of related URLs. Thereafter, the relationship component 108 may identify, through use of the information retrieved from the tag data store 104, the one or more users that bookmarked the foregoing URLs. The one or more users that tagged the one or more URLs comprising a given related set of URLs that have been tagged by a related set of tags comprise related users.

The relationship component 108 is operative to store the one or more related sets of tags, URLs, and users. The relationship data store 114 may comprise an accessible memory structure such as a database or digital storage library, capable of providing for the retrieval and storage of one or more sets of related tags, URLs, and users.

A recommendation component 110 at the content provider is operative to utilize the one or more sets of related tags, URLs, and users maintained in the relationship data store, as well as the one or more indices maintained in the tag data store, to generate a recommendation for a given user of a client device 124, 126, and 128. As previously described, a user may generate a bookmark for a given URL and indicate one or more tags associated with the bookmark through use of the tagging interface 112. The user specified tags, URL, and information identifying the user with which the request to generate the bookmark are delivered to the tag data store 104.

According to the embodiment illustrated in FIG. 1, the URL bookmarked by a given user, the tags associated with the bookmarked URL, and information identifying the user, may further be delivered to the recommendation component 110 at the content provider 100. According to one embodiment of the present invention, the recommendation component 110 is operative to perform a search of the tag data store 104 to identify one or more bookmarked URLs that have been tagged with the tags received by the recommendation component 110, and further retrieve such identified URLs. For example, a given user of a client device 124, 126, and 128 may bookmark a given URL and may indicate that the tag “food” is associated with the bookmarked URL. The bookmarked URL and the tag “food” may be delivered to the recommendation component 110. The recommendation component may perform a search of the tag data store 104 to identify the one or more URLs that are associated with the tag “food,” and may retrieve the one or more identified URLs.

The recommendation component 110 is further operative to identify one or more “experts” associated with a given tag received by the recommendation component 110. For example, as previously described, a user of a client device 124, 126, and 128 may bookmark a given URL and indicate that the tag “food” is associated with the URL. The recommendation component 110 may thereafter perform a search of the tag data store 104 and identify and retrieve the N users that most frequently tagged URLs with the tag “food.” For example, the recommendation component 110 may retrieve the ten (“10”) users that most frequently tagged URLs with the tag “food,” which may comprise the ten “experts” associated with the tag “food.”

The recommendation component 110 at the content provider 100 is further operative to retrieve the one or more sets of related tags, related URLs, and related users maintained in the relationship data store 114 and recommend one or more tags, users or URLs that may be of interest to the user that bookmarked a given URL. According to one embodiment of the present invention, the recommendation component 110 recommends one or more tags that are associated with the tags identified by the user for a given bookmarked URL through use of the one or more sets of related tags maintained from the relationship data store. For example, a given user may bookmark a URL and indicate that the tags “skateboarding” and “videos” are associated with the URL. The bookmarked URL and the tags “skateboarding” and “videos” may be delivered to the recommendation component 110. The recommendation component 110 may perform a search of the relationship data store 114 to identify one or more sets of related tags associated with the tags “skateboarding” and “videos,” such as identifying the one or more sets of related tags in which the tags “skateboarding” and “videos” appear. The one or more identified tags may further be ranked by the recommendation component 110, which may include, but is not limited to, ranking the one or more identified tags on the basis of the frequency with which the one or more identified tags appear in the one or more sets of related tags. The identified tags may be delivered to the tagging interface 112, which may display the tags to the user of the client device 124, 126, and 128.

According to another embodiment of the present invention, the recommendation component 110 recommends one or more URLs through use of the one or more sets of related URLs maintained in the relationship data store. For example, a given user of a client device 124, 126, and 128 may bookmark a given URL through use of the tagging interface 112. The bookmarked URL may be delivered to the recommendation component 110, which upon receipt of the URL may perform a search of the relationship data store 114 to locate one or more sets of related URLs in which the bookmarked URL appears. The recommendation component 110 may thereafter retrieve the one or more sets of related URLs in which the bookmarked URLs appears. According to one embodiment of the present invention, the recommendation component 110 ranks the one or more retrieved URLs comprising the one or more sets of related URLs, such as based upon the frequency with which the URLs comprising the one or sets of related URLs appear within the one or more sets of related URLs. The identified URLs may be delivered to the tagging interface 112, which may display the ranked URLs to the user of the client device 124, 126, and 128. The user of the client device 124, 126, and 128 may thereafter select one or more of the URLs through use of a selection device, such as a mouse or a keyboard.

According to a further embodiment of the present invention, the recommendation component 110 recommends one or more users through use of the one or more sets of related users maintained in the relationship data store. For example, a given user of a client device 124, 126, and 128 may bookmark a given URL through use of the tagging interface 112. The bookmarked URL, as well as information identifying the user of the client device 124, 126, and 128 that bookmarked the URL, may be delivered to the recommendation component 110. According to one embodiment of the present invention, the recommendation component performs a search of the relationship data store 114 to identify one or more sets of related users that similarly bookmarked the URL bookmarked by the user of the client device 124, 126, and 128.

The recommendation component 110 may thereafter retrieve the one or more identified sets of related users, which may subsequently be ranked. For example, the information associated with the one or more sets of related users may be used to rank the one or more users on the basis of the proximity of the one or more users to the user of the client device 124, 126, and 128 that bookmarked the URL received by the recommendation component. Alternatively, or in conjunction with the foregoing, the one or more sets of related users may be ranked on the basis of the frequency with which the one or more users bookmarked one or more URLs. The identified users may be delivered to the tagging interface 112, such as delivering icons associated with the one or more respective identified users, and may be displayed to the user of the client device 124, 126, and 128. The user of the client device 124, 126, and 128 may thereafter select a given related user, such as selecting an icon associated with a given related user, which may result in the display of the one or more bookmarks tagged by the related user, as well as the one or more tags utilized by the related user.

According to another embodiment of the present invention, the recommendation component 110 at the content provider is further operative to present the user of a client device 124, 126, and 128 with one or more popular sets of related tags, related URLs, and related users. As previously described, a user of a client device 124, 126, and 128 may bookmark a given URL and identify one or more tags associated with a bookmarked URL through use of the tagging interface 112. According to one embodiment of the present invention, the tagging interface 112 provides an indication to the recommendation component 110 of the occurrence of a user of a client device 124, 126, and 128 bookmarking a given URL.

Upon receipt of an indication that a given user of a client device 124, 126, and 128 has bookmarked a URL, the recommendation 110 retrieves the one or more sets of related tags, URLs, and users from the relationship data store 114. The recommendation component 110 is operative to thereafter identify one or more popular sets of related tags, URLs, and users. For example, the recommendation component 110 may identify the ten (“10”) most popular sets of related tags, which may comprise the ten sets of related tags that are associated with the greatest number of URLs. Similarly, the recommendation component 110 may identify the five (“5”) most popular sets of related URLs, which may comprise the ten most frequently bookmarked URLs by users of client devices 124, 126, and 128. Alternatively, or in conjunction with the foregoing, the recommendation may identify the ten (“10”) most popular sets of related users, which may comprise the ten users that have bookmarked the greatest number of URLs. The recommendation component 110 may thereafter deliver the one or more popular sets of related tags, URLs and users to the tagging interface 112, which may generate a display of the one or more popular sets of related tags, URLs, and users.

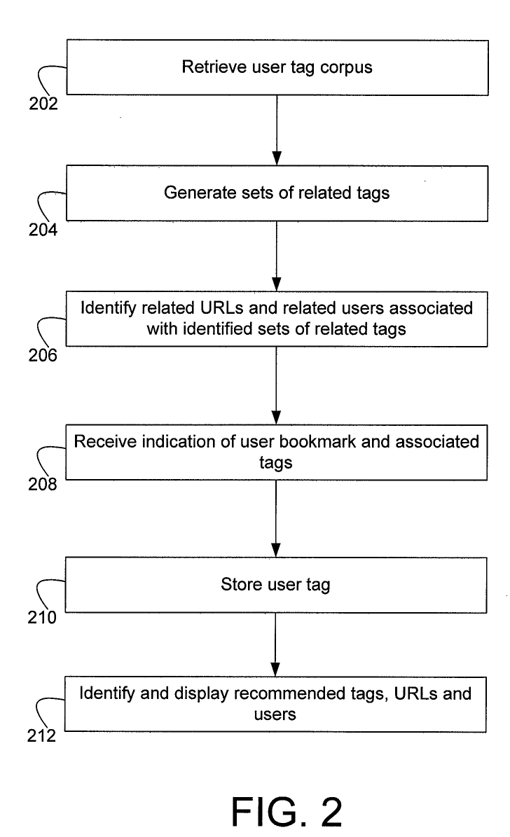

FIG. 2 is a flow diagram illustrating one embodiment of a method for discovering and displaying one or more relationships between users and content items, and generating a recommendation for a given user on the basis of the discovered relationships. According to the embodiment illustrated in FIG. 2, a corpus of one or more user tags associated with one or more URLs bookmarked by one or more users are retrieved, step 202. The corpus of retrieved tags may comprise one or more tags associated with one or more bookmarks generated by users during a given time period. Similarly, the corpus of retrieved tags may comprise the N tags associated with the greatest number of bookmarked URLs, wherein N comprises a positive integer.

According to the embodiment illustrated in FIG. 2, one or more sets of related tags are generated from the corpus of retrieved tags, step 204. According to one embodiment of the present invention, a given set of related tags comprises two or more tags that frequently co-occur within the corpus of retrieved tags. According to another embodiment of the present invention, a given set of related tags comprises two or more tags that frequently co-occur within a given corpus of content items, including, but not limited to, one or more blogs, one or more documents, one or more online questions/answers, or one or more web pages.

The one or more URLs and one or more users associated with the generated sets of related tags are thereafter identified, step 206. As previously described, a user may generate a bookmark for a given URL and identify one or more tags associated with the bookmarked URL. Accordingly, the one or more sets of related tags are associated with one or more URLs bookmarked by one or more users, which may be identified in step 206.

According to the embodiment illustrated in FIG. 2, an indication of a user generating a bookmark for a given URL and identifying one or more tags associated with the bookmarked URL is received, step 208. For example, a user of a client device may visit a given web page, such as www.yahoo.com, and through use of a bookmarking interface displayed to the user, the user may choose to bookmark the URL at which the web page may be accessed, and may further identify one or more tags associated with the bookmarked URL, such as “search engine.”

The one or more tags identified by the user as associated with the bookmarked URL, as well as the bookmarked URL, may subsequently be stored, step 210. Thereafter, one or more recommended tags, URLs and users are identified, according to methods described herein, and displayed to the user, step 212. According to one embodiment of the present invention, a recommended tag, URL, or user are identified through use of the one or more sets of related tags, related URLs, and related users generated in steps 204 and 206. For example, a search may be performed to identify the one or more sets of related tags in which the tags identified by the user in step 208 appear. The one or more identified sets of related tags may be ranked according to one or more ranking techniques and may comprise the recommended tags. Additionally, a search may be performed to identify the one or more sets of related URLs in which the URL bookmarked by the user in step 208 appears and may further be ranked, comprising the recommended URLs. Similarly, a search may be performed to identify the one or more sets of users associated with the user, which comprise the one or more recommended users.

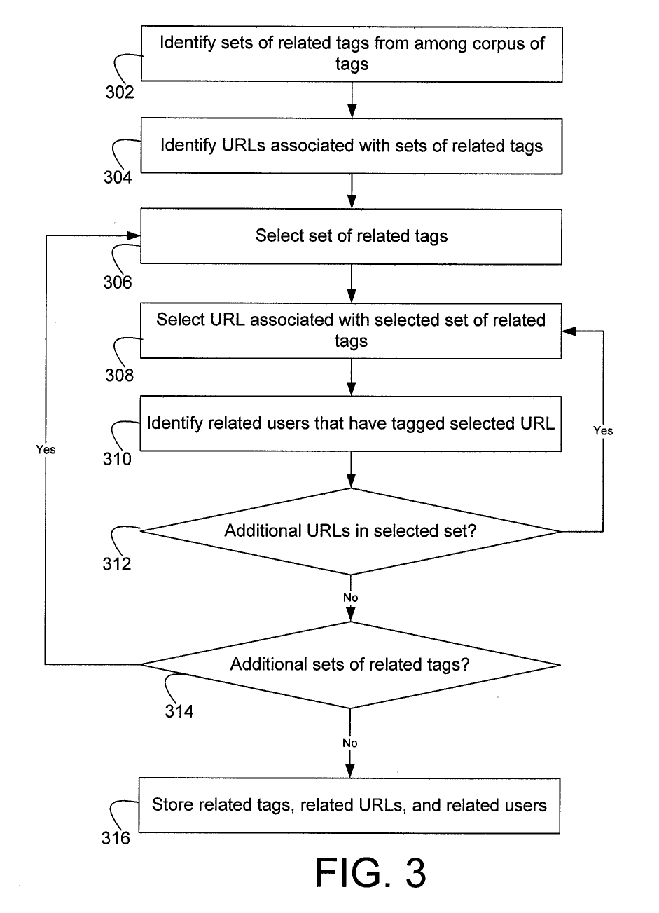

FIG. 3 illustrates one embodiment of a method for discovering relationships between users and content items on the basis of one or more tags associated with one or more bookmarks generated by one or more users. According to the embodiment illustrated in FIG. 3, one or more sets of related tags are identified from among a given corpus of tags, wherein a tag comprises one or more terms associated with a bookmark generated by a given user. According to one embodiment of the present invention, a given set of related tags comprises two or more tags that frequently co-occur in the corpus of tags, as identified through use of an association rule algorithm. For example, a predetermined threshold may be used to identify the one or tags that co-occur at least N times through use of an association rule algorithm.

According to another embodiment of the present invention, a given set of related tags comprises two or more tags that frequently co-occur in a given corpus of content items. For example, as previously described, a tag comprises one or more terms associated with a bookmarked URL. Accordingly, a search may be performed of one or more blogs, user generated questions and answers, web pages, documents, etc., to identify the frequency with which the terms comprising two or more tags co-occur. If the terms comprising two or more tags co-occur above a given threshold, the two or more tags may be identified as a set of related tags.

According to the embodiment illustrated in FIG. 3, one or more URLs associated with the identified set of related tags are thereafter identified, step 304. More specifically, the one or more URLs that have been tagged with the one or tags comprising a given set of related tags are identified. For example, a given set of related tags, as generated according to methods described herein, may comprise the tags “food store” and “online groceries.” A search may be performed to identify the one or more URLs that have been tagged with the tags “food store” and “online groceries.”

A given set of related tags is selected, step 306, and a URL associated with the selected set of related tags is selected, step 308. The one or more users that have bookmarked and tagged the selected URL, referred to herein as related users, are thereafter identified, step 310. For example, as previously described, a given set of related tags may comprise the tags “food store” and “online groceries,” which may be associated with URLS “URL1,” “URL2,” “URL3,” and “URL4.” “URL1” may be selected and the one or more users that tagged “URL1” with the tags “food store” and “online groceries” may be identified.

A check is performed to determine whether one or more additional URLs are associated with the selected set of related tags, step 312. If one or more additional URLs are associated with the selected set of related tags, another URL is selected, step 308. If no additional URLs are associated with the selected set of related tags, a subsequent check is performed to determine whether an analysis is required with respect to one or more additional sets of related tags, step 314. If one or more additional sets of related tags require analysis, another set of related tags is selected, step 306. After an analysis has been performed with respect to the one or more sets of related tags, the one or more sets of related tags, the one or more URLs associated with the one or more sets of related tags, and the one or more users associated with the one or more URLs, are stored, step 316. The stored sets of related tags, associated URLs and users may thereafter to be used to generate a recommendation for a given user, according to methods described herein.

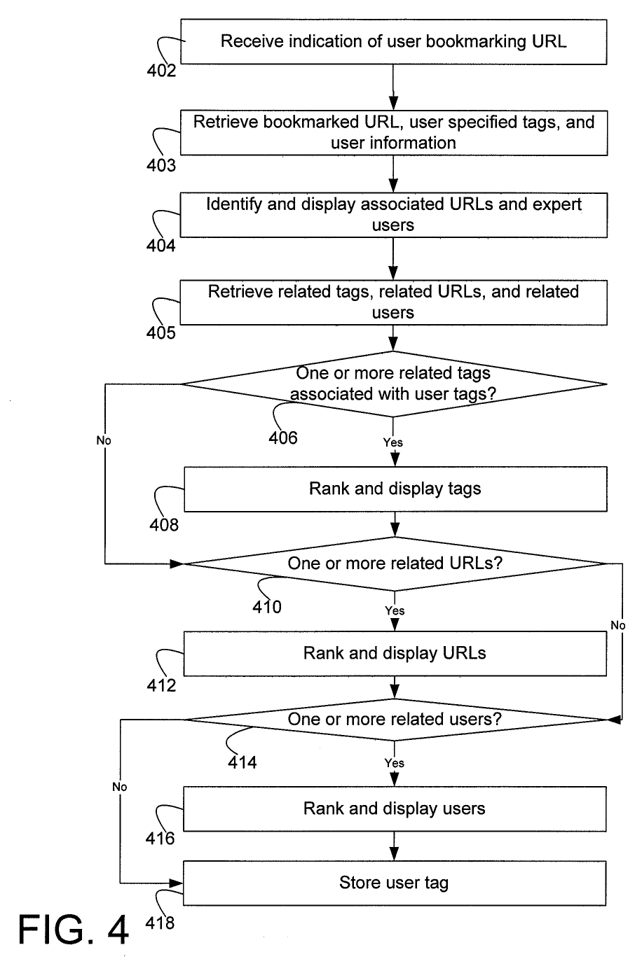

FIG. 4 is a flow diagram illustrating one embodiment of a method for generating a recommendation for a given user for a given bookmarked URL associated with one or more tags. According to the embodiment illustrated in FIG. 4, an indication of a user book marking a given URL is received, step 402. As previously described, a user may identify one or more tags associated with the URL that is bookmarked by the user, wherein a tag comprises one or more terms that a user associates with a given bookmarked URL. Accordingly, as illustrated in FIG. 4, the one or more user specified tags associated with the URL bookmarked by the user are retrieved, step 403.

As illustrated in FIG. 4, one or more URLs and one or more expert users associated with the tag received from the user are identified and displayed, step 404. According to one embodiment of the present invention, the one or more URLs that have been tagged with the tag received from the user are identified and displayed. For example, the tag received from the user may comprise the tag “food.” A search may be performed to identify the one or more URLs that have been tagged “food,” and the one or more identified tags may be displayed. Further, the one or more identified URLs may be ranked, such as on the basis of the frequency with which such URLs have been tagged “food.” Table 1 illustrates one embodiment of a display for identifying one or more URLs associated with a given user specified tag.

TABLE 1
FIRST 10/1000 URLS

| URLS | FREQUENCY |
|---|---|
| http://www.nytimes.com/2007/07/18/dining/18mini.html?ex=1342411200&en=44fa45164c [symbol] | 178 |
| http://www.nytimes.com/2007/07/18/dining/18mini.html?_r=2&oref=slogin&oref=slogi [symbol] | 77 |
| http://www.gadling.com/2007/07/26/the-best-8-beverages-in-the-world/ [symbol] | 71 |
| http://www.opensourcefood.com/ [symbol] | 63 |
| http://www.nytimes.com/2007/07/18/dining/18mini.html?ex=1342497600&en=e76301c448 [symbol] | 57 |
| http://www.eugeneciurana.com/musings/sushi-eating-HOWTO.html [symbol] | 56 |
| http://www.elise.com/recipes/archives/005255spicy_garlic_cashew_chicken.php [symbol] | 45 |
| http://www.nhs.uk/pages/gallery.html [symbol] | 34 |
| http://www.trifter.com/Practical-Travel/Budget-Travel/McDonalds-Strange-Menu-Aro [symbol] | 28 |
| http://www.wikihow.com/Cut-a-Watermelon [symbol] | 24 |

Table 1 illustrates the one or more URLs that are associated with the tag “food.” As illustrated in Table 1, the one or more URLs associated with the tag “food” are ranked according to the frequency with which such URLs have been tagged with the tag “food” by one or more users.

According to the embodiment illustrated in FIG. 4, one or more expert users associated with the tag received from the user are identified and displayed, step 404. According to one embodiment of the present invention, the one or more expert users associated with a given tag comprise the one or more users that most frequently tagged one or more URLs with a given tag. With reference to the abovementioned tag “food,” a search may be performed to identify the one or more users that most frequently tagged one or more URLs with the tag “food.” For example, a search may be performed to identify the ten (“10”) users that most frequently utilized the tag “food” to tag one or more URLs. Table 2 illustrates one embodiment of the expert users associated with the tag “food.”

TABLE 2
FIRST 10/1000 USERS

| USERS | FREQUENCY |
|---|---|
| off to ibiza | 52 |
| studioheliotrope | 48 |
| harmonious1 | 32 |
| aboynejames | 31 |
| amjojo | 30 |
| cocosete | 28 |
| roo | 22 |
| goutenscene | 21 |
| halblingefrau | 21 |
| dreamattack | 20 |

The embodiment illustrated in Table 2 identifies the ten (“10”) users that most frequently utilized the tag “food” to tag one or more URLs. According to one embodiment of the present invention, a given expert user may be selected, resulting in the display of the one or more URLs that have been tagged by the expert user, as well as the one or more tags utilized by the expert user. For example, with reference to Table 2, the expert user “off_to_ibiza” may be selected, resulting in the display of the one or more URLs that have been tagged by “off_to_ibiza,” as well as the one or more tags that “off_to_ibiza” has utilized. Table 3 illustrates one embodiment of the URLs and tags that may be displayed upon selection of the expert user “off_to_ibiza.”

TABLE 3

| FIRST 10/57 URLS | | FIRST 10/103 TOPIC WORDS | |
|---|---|---|---|
| URLS | FREQUENCY | TOPIC WORDS | FREQUENCY |
| http://www.slashfood.com/2007/07/02/fresh-pea-baby-potato-and-sweet-onion-soup/ [symbol] | 1 | recipe | 55 |
| http://www.slashfood.com/2007/06/21/thai-style-tom-ka-green-curry-fish-soup/ [symbol] | 1 | food | 52 |
| http://www.slashfood.com/2007/06/13/i-think-ill-make-some-brownies/ [symbol] | 1 | food, recipe | 50 |
| http://www.slashfood.com/2007/05/25/grilled-black-bean-quesadillas-with-spinach- [symbol] | 1 | cooking | 42 |
| http://www.nytimes.com/2007/07/18/dining/18mini.html?_r=1&oref=slogin&ref=dining [symbol] | 1 | recipe, cooking | 40 |
| http://www.foodnetwork.com/food/wd_basics/text/0,1975,FOOD_10016_11431,00.html [symbol] | 1 | food, cooking | 38 |
| http://www.epicurious.com/recipes/recipe_views/views/238698 [symbol] | 1 | food, recipe, cooking | 36 |
| http://www.elise.com/recipes/archives/005255spicy_garlic_cashew_chicken.php [symbol] | 1 | soup | 7 |
| http://www.elise.com/recipes/archives/005220stovetop_baked_beans.php [symbol] | 1 | recipe, soup | 7 |
| http://www.elise.com/recipes/archives/005203jerk_chicken.php [symbol] | 1 | recipe, fish | 6 |

Table 3 illustrates the one or more URLs that have been tagged by the user “off_to_ibiza.” Further, table 3 illustrates the one or more tags that have been utilized by the user “off_to_ibiza” to tag one or more URLs. As illustrated in Table 3, the tags utilized by “off_to_ibiza” are ranked according to the frequency with which “off_to_ibiza” utilized the one or more tags to tag one or more URLs.

In addition to the foregoing, a given URL displayed, such as the one or more URLs displayed in Table 1 and Table 3, may be selected. According to one embodiment of the present invention, upon selection of a given displayed URL, the one or more tags with which the selected URL has been tagged, and the one or more users that have tagged the selected URL, are displayed. Table 4 illustrates one embodiment of the tags and users that may be displayed upon selection of the URL “http://www.gadling.com/2007/07/26/the-best-8-beverages-in-the-world/,” displayed in Table 1.

TABLE 4

| FIRST 10/86 TOPIC WORDS | | FIRST 10/104 USERS | |
|---|---|---|---|
| TOPIC WORDS | FREQUENCY | USERS | FREQUENCY |
| food | 71 | xtrmntr | 1 |
| drinks | 61 | wrigpa | 1 |
| beverage | 51 | wjhicks | 1 |
| travel | 41 | vlaszlo | 1 |
| food, drinks | 41 | violentvinyl | 1 |
| drinks, beverage | 39 | vinch | 1 |
| travel, food | 34 | venukb | 1 |
| food, beverage | 33 | trp0 | 1 |
| list | 30 | tkoudsi | 1 |
| food, drinks, beverage | 27 | timhwang | 1 |

Table 4 identifies the one or more tags that have been utilized by users to tag the URL “http://www.gadling.com/2007/07/26/the-best-8-beverages-in-the-world/.” Further, Table 4 identifies the one or more users that have tagged the URL “http://www.gadling.com/2007/07/26/the-best-8-beverages-in-the-world/” with one or more of the identified tags.

According to the embodiment illustrated in FIG. 4, one or more sets of related tags, related URLs, and related users, generated according to methods described herein, are retrieved, step 405. A search is performed of the one or more sets of related tags to identify whether one or more sets of related tags are associated with the user specified tags, step 406. According to one embodiment of the present invention, a search is performed to identify one or more sets of related tags in which the user specified tags appear. For example, as previously described, the user specified tag retrieved in step 403 may comprise the tag “food.” Accordingly, a search may be performed to identify one or more sets of related tags in which the tag “food” appears.

According to the embodiment illustrated in FIG. 4, if one or more sets of related tags associated with the user specified tag have been identified, the identified sets of related tags are ranked and displayed, step 408. For example, the one or more identified sets of related tags may be ranked according to the quantity of bookmarked URLs with which the tags are associated. Alternatively, or in conjunction with the foregoing, the one or more identified sets of related tags may be ranked according to the quantity of users that utilize the tags in bookmarking one or more URLs. Those of skill in the art recognize the plurality of techniques that may be used for ranking one or more sets of related tags.

If one or more sets of related tags associated with the user specified tags are not identified, or after the one or more sets of related tags are ranked and displayed, a search is performed to identify one or more sets of related URLs associated with the URL bookmarked the user, step 410. The search performed in step 410 may comprise a search to identify one or more sets of related URLs in which the URL bookmarked by the user appears. For example, the URL bookmarked by the user may comprise the URL “URL1.” A first given set of related URLs may comprise the URLs “URL2,” “URL7,” and “URL12.” A second given set of related URLs may comprise the URLs “URL1,” “URL17,” and “URL25.” The search performed in step in 410 may not identify the foregoing first set of related URLs as associated with “URL1,” as “URL1” does not appear in the first set of related URLs. The search performed in step 410, however, may identify the foregoing second set of related URLs as associated with “URL1” bookmarked by the user, as “URL1” appears in the second set of related URLs.

If one or more sets of related URLs are identified, the one or more URLs are ranked and displayed, step 412. For example, the one or more URLs may be ranked according to the frequency with which the one or more URLs have been ranked by one or more users. According to one embodiment of the present invention, the one or more URLs are displayed in conjunction with the one or more tags associated with the one or more URLs. Alternatively, or in conjunction with the foregoing, the one or more URLs are displayed in conjunction with information identifying the one or more users that bookmarked and tagged the one or more URLs, such as icons associated with a given user.

After the one or more related URLs have been ranked and displayed, or if no related URLs are identified, a search is performed to identify one or more sets of related users, step 414. As previously described, a related user may comprise a user that bookmarked the URL retrieved in step 403. Alternatively, or in conjunction with the foregoing, a related user may comprise a user that utilized the one or more user specified tags received in step 403.

According to the embodiment illustrated in FIG. 4, if one or more related users are identified, the one or more related users are ranked, such as according to the frequency with which the one or more users bookmarked one or more URLs, and subsequently displayed. The bookmarked URL, user specified tags, and user information, received in step 403, are thereafter stored. The stored bookmarked URL, user specified tags, and user information may be used to identify related tags, related URLs, and related users in response to receiving a subsequent indication of a user bookmarking a given URL, as described with respect to step 402.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for discovering relationships between one or more content items and one or more users:
retrieving one or more bookmarks and one or more tags associated with one or more uniform resource locators (“URL”) generated by one or more users;
generating one or more sets of related tags according to a frequency with which the one or more retrieved tags co-occur within a given corpus of content items;
identifying the one or more URLs associated with the one or more identified sets of related tags, wherein the one or more URLs associated with a given set of related tags comprises a set of related URLs;
identifying the one or more users that generated bookmarks for the one or more sets of related URLs associated with the one or more identified sets of related tags, wherein the one or more users associated with a given set of related URLs comprises a set of related users; and
generating a recommendation for one or more tags, one or more URLs, and one or more users in response to receiving an indication of a user generating a bookmark for a given URL through use of the one or more sets of related tags, related URLs, and related users.

2. The method of claim 1 wherein generating one or more sets of related tags comprises:
identifying a frequency with which the one or more of the retrieved tags co-occur within a given corpus of content items; and
identifying the one or more retrieved tags that co-occur above a given threshold; and
generating one or more sets of related tags based upon the one or more retrieved tags that co-occur above the threshold.

3. The method of claim 1 wherein generating a recommendation for one or more tags, one or more URLs, and one or more users comprises:
receiving an indication of a user generating a bookmark for a given URL, the bookmark associated with one or more user specified tags;
retrieving the one or more sets of related tags associated with the one or more user specified tags;
retrieving the one or more sets of related URLs associated with the one or more identified sets of related tags;
retrieving the one or more sets of related users associated with the one or more identified sets of related URLs; and
displaying the one or more retrieved sets of related tags, related URLs, and related users.

4. The method of claim 3 wherein retrieving the one or more sets of related tags associated with the one or more user specified tags comprises retrieving the one or more sets of related tags in which the user specified tags appear.

5. The method of claim 3 wherein displaying comprises;
ranking the one or more retrieved sets of related tags, related URLs and related users; and
displaying the one or more retrieved sets of related tags, related URLs, and related users according to the ranking.

6. The method of claim 5 wherein displaying comprises displaying the one or more retrieved sets of related tags, related URLs, and related users above a given ranking threshold.

7. A system for discovering relationships between one or more content items and one or more users:
a relationship component operative to:
retrieve one or more bookmarks and one or more tags associated with one or more URLs generated by one or more users;
generate one or more sets of related tags according to a frequency with which the one or more retrieved tags co-occur within a given corpus of content items;
identify the one or more URLs associated with the one or more identified sets of related tags, wherein the one or more URLs associated with a given set of related tags comprises a set of related URLs; and
identify the one or more users that generated bookmarks for the one or more sets of related URLs associated with the one or more identified sets of related tags, wherein the one or more users associated with a given set of URLs comprises a set of related users; and
a recommendation component operative to:
receive an indication of a user generating a bookmark for a given URL, the bookmark associated with one or more user specified tags; and
generate a recommendation for one or more tags, one or more URLs, and one or more users associated with the one or more user specified tags through use of the one or more related tags, related URLs, and related users.

8. The method of claim 7 wherein the relationship component is operative to:
identify a frequency with which the one or more retrieved tags co-occur within a given corpus of content items; and
identify the one or more retrieved tags that co-occur above a given threshold; and
generate one or more sets of related tags based upon the one or more retrieved tags that co-occur above the threshold.

9. The system of claim 7 wherein the recommendation component is operative to:
receive an indication of a user generating a bookmark for a given URL, the bookmark associated with one or more user specified tags;
retrieve the one or more sets of related tags associated with the one or more user specified tags;
retrieve the one or more sets of related URLs associated with the one or more identified sets of related tags;
retrieve the one or more sets of related users associated with the one or more identified sets of related URLs; and
generate a ranking of the one or more retrieved sets of related tags, related URLs and related users.

10. The system of claim 9 wherein the recommendation component is operative to retrieve the one or more sets of related tags in which the user specified tags appear.

11. The system of claim 9 wherein the recommendation component is operative to select the one or more retrieved sets of related tags, related URLs, and related users above a given ranking threshold.

12. The system of claim 10 further comprising a tagging interface operative to display the one or more identified sets of related tags, related URLs, and related users selected by the recommendation component.

13. Computer readable media comprising program code for execution by a programmable processor to perform a method for discovering relationships between one or more content items and one or more users:
program code for retrieving one or more bookmarks and one or more tags associated with one or URLs generated by one or more users;
program code for generating one or more sets of related tags according to a frequency with which the one or more retrieved tags co-occur within a given corpus of content items;
program code for identifying the one or more URLs associated with the one or more identified sets of related tags, wherein the one or more URLs associated with a given set of related tags comprises a set of related URLs;
program code for identifying the one or more users that generated bookmarks for the one or more sets of related URLs associated with the one or more identified sets of related tags, wherein the one or more users associated with a given set of URLs comprises a set of related users; and
program code for generating a recommendation for one or more tags, one or more URLs, and one or more users in response to receiving an indication of a user generating a bookmark for a given URL through use of the one or more sets of related tags, related URLs, and related users.

14. The computer readable media of claim 13 wherein the program code for generating one or more sets of related tags comprises:
program code for identifying a frequency with which the one or more of the retrieved tags co-occur within a given corpus of content items; and
program code for identifying the one or more retrieved tags that co-occur above a given threshold; and
program code for generating one or more sets of related tags based upon the one or more retrieved tags that co-occur above the threshold.

15. The computer readable media of claim 13 wherein the program code for generating a recommendation for one or more tags, one or more URLs, and one or more users comprises:
program code for receiving an indication of a user generating a bookmark for a given URL, the bookmark associated with one or more user specified tags;
program code for retrieving the one or more sets of related tags associated with the one or more user specified tags;
program code for retrieving the one or more sets of related URLs associated with the one or more identified sets of related tags;
program code for retrieving the one or more sets of related users associated with the one or more identified sets of related URLs; and
program code for displaying the one or more identified sets of related tags, related URLs, and related users.

16. The computer readable media of claim 15 wherein the program code for retrieving the one or more sets of related tags associated with the one or more user specified tags comprises program code for retrieving the one or more sets of related tags in which the user specified tags appear.

17. The computer readable media of claim 15 wherein the program code for displaying comprises;
program code for ranking the one or more identified sets of related tags, related URLs and related users; and
program code for displaying the one or more identified sets of related tags, related URLs, and related users according to the ranking.

18. The computer readable media of claim 17 wherein the program code for displaying comprises program code for displaying the one or more identified sets of related tags, related URLs, and related users above a given ranking threshold.
